(19) United States
(12) Patent Application Publication
(10) Pub. No.: US 2013/0247734 A1
(43) Pub. Date: Sep. 26, 2013

(54) Apparatus for Manufacturing Cut Glass Fibres

(71) Applicant: Ulrich Singer, Dorfles Esbach (DE)

(72) Inventor: Ulrich Singer, Dorfles Esbach (DE)

(73) Assignee: DIETZE & SCHELL MASCHINENFABRIK GMBH & CO. KG, Coburg (DE)

(21) Appl. No.: 13/596,094

(22) Filed: Aug. 28, 2012

(30) Foreign Application Priority Data
Mar. 22, 2012 (EP) 12 160 715.4

(51) Int. Cl. B26D 7/26; B26D 3/00; B65H 35/00

(52) U.S. Cl. 83/401; 83/591; 83/571; 83/552; 83/438

(57) ABSTRACT

The present invention relates to an apparatus for manufacturing cut glass fibres, whereby the apparatus comprises at least one first cot wheel and at least one second cot wheel, a first cutter head and a second cutter head, whereby the apparatus is configured such that the apparatus is operable in at least one first operation mode in which at least one of the cot wheels and at least one of the cutter heads are capable to cut inline glass fibres from a yarn, preferably from an endless yarn.

### CROSS-REFERENCE TO RELATED APPLICATIONS

This application claims the benefit of European Patent Application No. 12 160 715.4 filed Mar. 22, 2012, incorporated by reference herein in its entirety.

### BACKGROUND OF THE INVENTION

The present invention generally relates to an apparatus for manufacturing cut glass fibres.

### BRIEF SUMMARY OF THE INVENTION

In one embodiment there is an apparatus for manufacturing cut glass fibres comprising: at least one first cot wheel and at least one second cot wheel, a first cutter head and a second cutter head, whereby the apparatus is configured such that the apparatus is operable in at least one first operation mode in which at least one of the cot wheels and at least one of the cutter heads are capable to cut inline glass fibres from a yarn, preferably from an endless yarn. In one embodiment, the first cot wheel and the second cot wheel are mounted on a cot turret, whereby the cot turret is movable from a first position to a second position and from the second position to the first position. In one embodiment, the first position of the cot turret is a position, in which the first cot wheel is in an operating position for cutting glass fibres inline and/or that the second position of the cot turret is a position, in which the second cot wheel is in an operating position for cutting glass fibres inline.

In one embodiment, the first position of the cot turret is a position, in which the second cot wheel is in a non-operating position and detachable and/or that the second position of the cot turret is a position, in which the first cot wheel is in a non-operating position and detachable, whereby preferably in the first position of the cot turret the second cot wheel is accessible through at least one safety door and/or whereby preferably in the second position of the cot turret the first cot wheel is accessible through the at least one safety door. In one embodiment, the cot turret is rotatable around a cot turret axis and that the first cot wheel is rotatable around a first cot wheel axis and the second cot wheel is rotatable around a second cot wheel axis, whereby the cot turret axis, the first cot wheel axis and the second cot wheel axis are substantially parallel.

In one embodiment, the first cutter head and the second cutter head are mounted on a cutterhead turret, whereby the cutterhead turret is movable from a first position to a second position and from the second position to the first position. In one embodiment, the first position of the cutterhead turret is a position, in which the first cutter head is in an operating position for cutting glass fibres inline and/or that the second position of the cutterhead turret is a position, in which the second cutter head is in an operating position for cutting glass fibres inline. In one embodiment, the first position of the cutterhead turret is a position, in which the second cutter head is in a non-operating position and detachable and/or that the second position of the cutterhead turret is a position, in which the first cutter head is in a non-operating position and detachable, whereby preferably in the first position of the cutterhead turret the second cutter head is accessible through at least one safety door and/or whereby preferably in the second position of the cutterhead turret the first cutter head is accessible through the at least one safety door.

In one embodiment, the cutterhead turret is rotatable around a cutterhead turret axis and that the first cutter head is rotatable around a first cutter head axis and the second cutter head is rotatable around a second cutter head axis, whereby the cutterhead turret axis, the first cutter head axis and the second cutter head axis are substantially parallel. In one embodiment, the apparatus comprises at least one idler, whereby the idler is configured such that the yarn can be guided by means of the idler. In one embodiment, the apparatus comprises at least one movable idler being movable from at least a first position to a second position and backwards. In one embodiment, the movable idler is configured such that by moving from the first position to the second position the yarn is guided into the cot wheel being in the non-operating position, preferably during the automatic change-over process when changing from the first cot wheel to the second cot wheel or from the second cot wheel to first cot wheel and/or that the movable idler is configured such that by moving from the first position to the second position the yarn is guided into the cot wheel being in the operating position for cutting glass fibres inline, preferably during the automatic starting of the insertion and cutting process of the yarn.

In one embodiment, the apparatus comprises at least one set of at least two pulley wheels, whereby the pulley wheels are configured such that the pulley wheels are capable to pull the yarn, preferably during the automatic starting of the insertion and cutting process of the yarn. In one embodiment, the apparatus comprises at least one movable press roller being movable from at least a first position to a second position and backwards, whereby preferably the movable press roller is configured such that by moving from the first position to the second position the yarn is guided into the cot wheel being in the operating position for cutting glass fibres inline, preferably during the automatic starting of the insertion and cutting process of the yarn. In one embodiment, the apparatus comprises at least one oscillating comb, which is configured such that the incoming yarn is guided by the oscillating comb.

### BRIEF DESCRIPTION OF THE SEVERAL VIEWS OF THE DRAWINGS

The foregoing summary, as well as the following detailed description of embodiments of the apparatus for manufacturing cut glass fibres, will be better understood when read in conjunction with the appended drawings of an exemplary embodiment. It should be understood, however, that the invention is not limited to the precise arrangements and instrumentalities shown.

In the drawings:

FIG. 1 is a schematic drawing of a chopper according to the present invention;

FIG. 2 is a schematic drawing of the arrangement of the cutting head and the cot wheel of the chopper according to the present invention;

FIG. 3 is a further schematic drawing of the arrangement of the cutting head and the cot wheel of the chopper according to the present invention;

FIG. 4 is a further schematic drawing of the chopper according to the present invention;

FIG. 5 is a further schematic drawing of the chopper according to the present invention during the automatic application of a first strand in a first step;

FIG. 6 is a further schematic drawing of the chopper according to the present invention during the automatic application of a first strand in a second step;

FIG. 7 is a further schematic drawing of the chopper according to the present invention during the automatic application of a first strand in a third step;

FIG. 8 is a further schematic drawing of the chopper according to the present invention during the cutting in operation;

FIG. 9 is a further schematic drawing of the chopper according to the present invention during the automatic application of a strand in a first step;

FIG. 10 is a further schematic drawing of the chopper according to the present invention during the automatic application of a strand in a second step;

FIG. 11 is a further schematic drawing of the chopper according to the present invention during the automatic application of a strand in a third step;

FIG. 12 is a further schematic drawing of the chopper according to the present invention during the automatic application in a first step;

FIG. 13 is a further schematic drawing of the chopper according to the present invention during the automatic application in a second step;

FIG. 14 is a further schematic drawing of the chopper according to the present invention during the automatic application in a third step;

FIG. 15 is a further schematic drawing of the chopper according to the present invention during the automatic application in a fourth step;

FIG. 16 is a further schematic drawing of the chopper according to the present invention during exchange of the cutter head and the cot wheel during operation;

FIGS. 17a, b are schematic drawings illustrating details of the cot wheel; and

FIG. 18 is a schematic drawing of an alternative embodiment which comprises engine-driven cutter heads.

### DETAILED DESCRIPTION OF THE INVENTION

For the inline manufacturing of cut glass fibres machines are used, which are equipped with a cot wheel (drive wheel) and a cutting head. These machines are so-called choppers.

The cutter head is driven by the rotating cot wheel by means of friction. At least one glass fibre yarn is fed from a glass yarn spinning machine to the chopper, handled by the machine by means of several cylinders and/or wheels and cut by the cutter head.

Since the cutter head and the cot wheel are subject to abrasive wear due to the kind of actuation of the cutter head and due to the normal wear caused by the cutting procedure of the glass fibres, the cutter head and the cot wheel have to be exchanged from time to time. Both the cutter head and the cot wheel are the most prominent wear parts of the chopper, since these parts are directly involved in the cutting process and thus subject to extensive wear and loads.

During an exchange process of the cot wheel and the cutter head the whole machine has to be stopped and thus the production process of manufacturing cut glass fibres has to be interrupted.

It is therefore an object of the present invention to improve an apparatus for manufacturing cut glass fibres in particular in that the exchange of the cot wheel and the cutter head is simplified and that the interruption time of the chopper during exchange of the cot wheel and the cutter head is reduced.

An apparatus for manufacturing cut glass fibres is provided, whereby the apparatus comprises at least one first cot wheel and at least one second cot wheel, a first cutter head and a second cutter head, whereby the apparatus is configured such that the apparatus is operable in at least one first operation mode in which at least one of the cot wheels and at least one of the cutter heads are capable to cut inline glass fibres from a yarn, preferably from an endless yarn.

The apparatus for manufacturing cut glass fibres can be a so-called chopper, for instance preferably an inline chopper that automatically runs along for manufacturing cut glass fibres more or less directly after the spinning nozzle of the spinning machine. The machines are so-called choppers and the cut glass fibres are so-called chopped glass fibres.

Thereby, the advantage is achieved that at least one pair of a cot wheel and a cutter head is capable to operate and to be used for cutting of a yarn. The other pair of cot wheel and cutter head is in a non-operating state and can thus be exchanged easily. It is possible that the cot wheel und cutter head being in operation can be changed, so that the cot wheel und cutter head being not in operation can be used for the cutting process.

The yarn or, as it is also possible, a plurality of yarns can be provided by at least one spinning machine comprising one or more spinning nozzles. Especially, the exchange of the cot wheel and the cutter head is simplified and the interruption time of the apparatus for manufacturing of cut glass fibres during exchange of the cot wheel and the cutter head is reduced.

It is especially possible that the first cot wheel and the second cot wheel are mounted on a cot turret, whereby the cot turret is movable from a first position to a second position and from the second position to the first position. By means of the cot turret the exchange of the positions of the first and second cot wheel is simplified.

Moreover, the first position of the cot turret may be a position, in which the first cot wheel is in an operating position for cutting glass fibres inline and/or that the second position of the cot turret may be a position, in which the second cot wheel is in an operating position for cutting glass fibres inline.

Additionally, it is possible that the first position of the cot turret is a position, in which the second cot wheel is in a non-operating position and detachable and/or that the second position of the cot turret is a position, in which the first cot wheel is in a non-operating position and detachable, whereby preferably in the first position of the cot turret the second cot wheel is accessible through at least one safety door and/or whereby preferably in the second position of the cot turret the first cot wheel is accessible through the at least one safety door. The safety door(s) may be e.g. interlinked with a control means of the apparatus, which is configured such that in an unsafe state for opening the safety door is locked, e.g. during the rotation of the cot turret.

Furthermore, it is possible that the cot turret is rotatable around a cot turret axis and that the first cot wheel is rotatable around a first cot wheel axis and the second cot wheel is rotatable around a second cot wheel axis, whereby the cot turret axis, the first cot wheel axis and the second cot wheel axis are substantially parallel.

Moreover, it is possible that the first cutter head and the second cutter head are mounted on a cutterhead turret, whereby the cutterhead turret is movable from a first position to a second position and from the second position to the first position.

It is further possible that the first position of the cutterhead turret is a position, in which the first cutter head is in an operating position for cutting glass fibres inline and/or that the second position of the cutterhead turret is a position, in which the second cutter head is in an operating position for cutting glass fibres inline.

Preferably, the first position of the cutterhead turret may be a position, in which the second cutter head is in a non-operating position and detachable and/or that the second position of the cutterhead turret may be a position, in which the first cutter head is in a non-operating position and detachable, whereby preferably in the first position of the cutterhead turret the second cutter head is accessible through at least one safety door and/or whereby preferably in the second position of the cutterhead turret the first cutter head is accessible through the at least one safety door.

Additionally, it is possible that the cutterhead turret is rotatable around a cutterhead turret axis and that the first cutter head is rotatable around a first cutter head axis and the second cutter head is rotatable around a second cutter head axis, whereby the cutterhead turret axis, the first cutter head axis and the second cutter head axis are substantially parallel.

Furthermore, it is possible that the apparatus comprises at least one idler, whereby the idler is configured such that the yarn can be guided by means of the idler.

Moreover, the apparatus may comprise at least one movable idler being movable from at least a first position to a second position and backwards.

It is possible that the movable idler is configured such that by moving from the first position to the second position the yarn is guided into the cot wheel being in the non-operating position, preferably during the automatically change-over process when changing from the first cot wheel to the second cot wheel or from the second cot wheel to first cot wheel and/or that the movable idler is configured such that by moving from the first position to the second position the yarn is guided into the cot wheel being in the operating position for cutting glass fibres inline, preferably during the automatic starting of the insertion and cutting process of the yarn.

Furthermore, it is possible that the apparatus comprises at least one set of at least two pulley wheels, whereby the pulley wheels are configured such that the pulley wheels are capable to pull the yarn, preferably during the automatic starting of the insertion and cutting process of the yarn.

Additionally, the apparatus may comprise at least one movable press roller being movable from at least a first position to a second position and backwards, whereby preferably the movable press roller is configured such that by moving from the first position to the second position the yarn is guided into the cot wheel being in the operating position for cutting glass fibres inline, preferably during the automatic starting of the insertion and cutting process of the yarn.

It is further possible that the apparatus comprises at least one oscillating comb, which is configured such that the incoming yarn is guided by the oscillating comb.

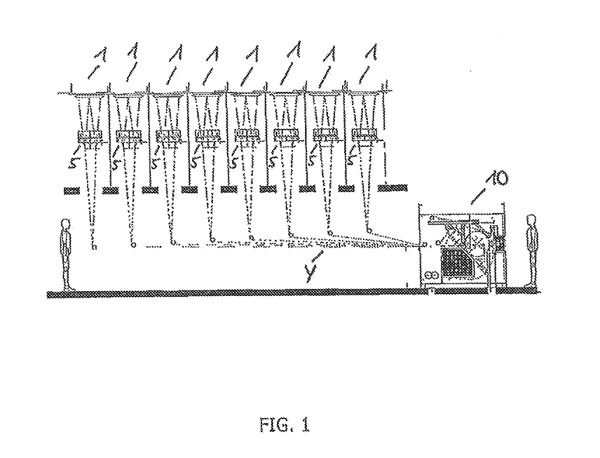

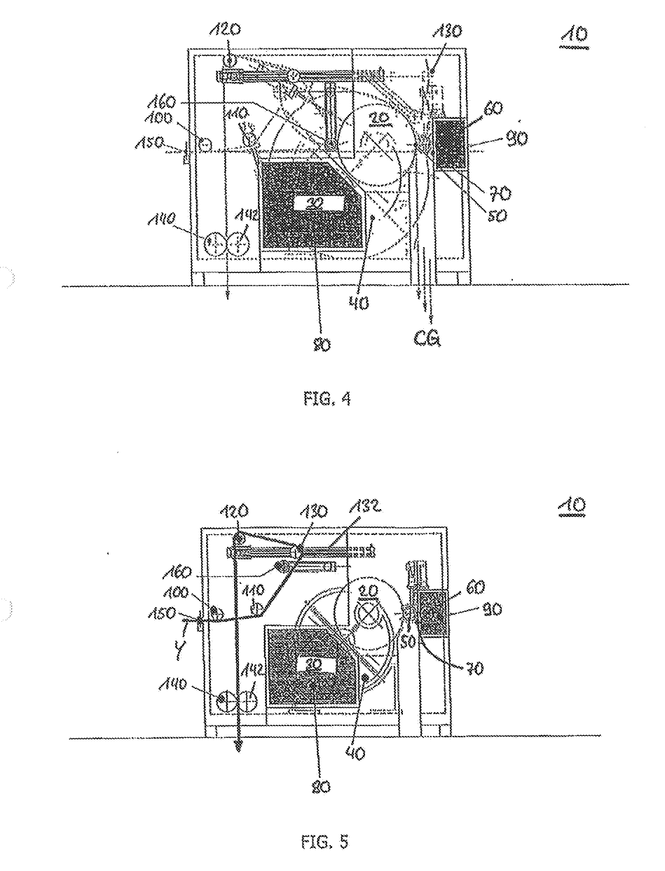

FIG. 1 shows a schematic drawing of an apparatus 10 for manufacturing of cut glass fibres CG (see also e.g. FIG. 4), in particular an automatic shifting chopper 10 according to the present invention.

A plurality of glass fibre yarns Y, which is produced by several spinning machines 1 comprising e.g. common spinning nozzles 5, is transferred to and fed into the automatic inline chopper 10 for the cutting process.

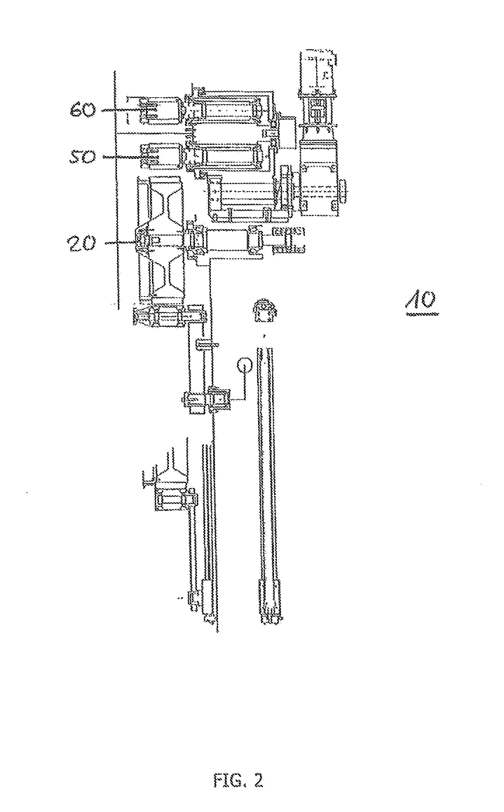

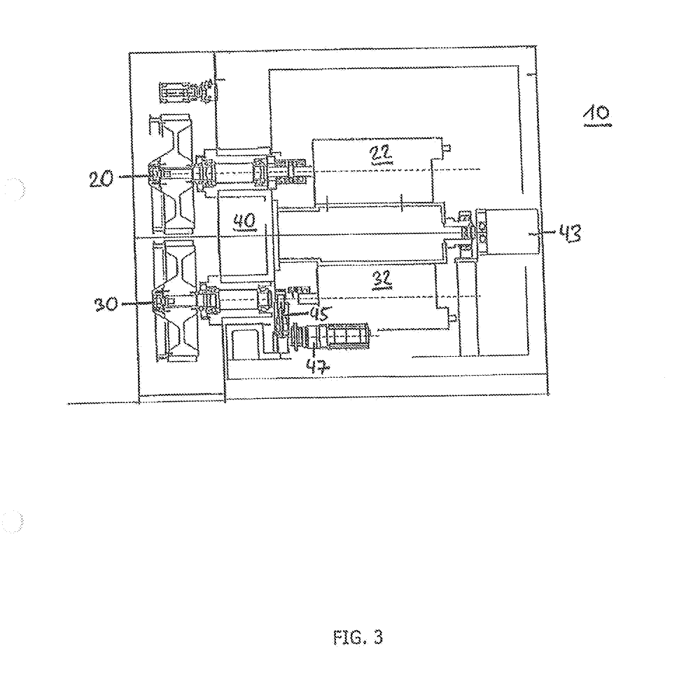

As can be derived from FIGS. 2 and 3, the apparatus 10 comprises at least one first cot wheel 20 and at least one second cot wheel 30, a first cutter head 50 and a second cutter head 60, whereby the apparatus 10 is configured such that the apparatus is operable in at least one first operation mode in which at least one of the cot wheels 20, 30 and at least one of the cutter heads 50, 60 are capable to cut inline glass fibres CG from the endless yarn Y produced by the spinning machines 1.

As shown in FIG. 2, the cot wheel 20 being in the operating position is engaged with the cutting head 50 also being in the operating position. The cutting head is rotated by means of friction and the rotation of the cot wheel 20.

FIG. 3 shows that the cot wheel 20 may be driven by a spindle drive 22 and that the cot wheel 30 may be driven by the spindle drive 32. The power supply to the spindle drives 22, 32 is established via a slip ring 43.

The first cot wheel 20 and the second cot wheel 30 are mounted on a cot turret 40, whereby the cot turret 40 is movable from a first position to a second position and from the second position to the first position.

The first position of the cot turret 40, which is shown in FIGS. 2 and 3, is a position, in which the first cot wheel 20 is in an operating position for cutting glass fibres CG inline. The cot turret 40 can be rotated by means of a servomotor, here a turret drive 47 with a belt. The cot turret 40 can be rotated and there is a second position of the cot turret 40, in which the second cot wheel 30 is in an operating position for cutting glass fibres CG inline. The cot turret axis, the first cot wheel axis and the second cot wheel axis are substantially parallel. To determine the actual cot turret position an index bolt 45 is provided.

Moreover, the first position of the cot turret 40 is a position, in which the second cot wheel 30 is in a non-operating position and detachable and the second position of the cot turret 40 is a position, in which the first cot wheel 20 is in a non-operating position and detachable.

FIG. 4 shows a further schematic drawing of the chopper 10 according to the present invention.

As shown in FIG. 4, in the first position of the cot turret 40 the second cot wheel 30 is accessible through a safety door 80 and in the second position of the cot turret 40 the first cot wheel 20 is accessible through the safety door 80. The safety door 80 can be opened during operation of the chopper 10 to unmount or exchange the cot wheel located behind the safety door 80.

The first cutter head 50 and the second cutter head 60 are mounted on a cutterhead turret 70, whereby the cutterhead turret 70 is rotatable from a first position to a second position and from the second position to the first position. The cutterhead turret 70 is rotatable around a cutterhead turret axis and the first cutter head 50 is rotatable around a first cutter head axis and the second cutter head 60 is rotatable around a second cutter head axis, whereby the cutterhead turret axis, the first cutter head axis and the second cutter head axis are substantially parallel.

The first position of the cutterhead turret 70 is a position, in which the first cutter head 50 is in an operating position for cutting glass fibres CG inline and the second position of the cutterhead turret 70 is a position, in which the second cutter head 60 is in an operating position for cutting glass fibres CG inline.

The first position of the cutterhead turret 70 is a position, in which the second cutter head 60 is in a non-operating position and detachable and the second position of the cutterhead turret 70 is a position, in which the first cutter head 50 is in a non-operating position and detachable. In the first position of the cutterhead turret 70 the second cutter head 60 is accessible through the safety door 90 and in the second position of the cutterhead turret 70 the first cutter head 50 is accessible through the safety door 90.

The chopper 10 comprises an oscillating comb 150, which is configured such that the incoming yarn Y is guided by the oscillating comb 150. Moreover, the chopper 10 comprises idlers 100, 110, 120, 130, whereby the idlers 100, 110, 120, 130 are configured such that the yarn Y can be guided by means of the idler 100, 110, 120, 130. The idlers 110, 130 are movable idlers 110, 130 and are movable from at least a first position to a second position and vice versa.

Furthermore, a set of two pulley wheels 140, 142 is provided, whereby the pulley wheels 140, 142 are configured such that the pulley wheels 140, 142 are capable to pull the yarn Y, preferably during the automatic application of the yarn Y. Additionally, the chopper 10 comprises one movable press roller 160 being movable from a first position to a second position and vice versa, whereby the movable press roller 160 is configured such that by moving from the first position to the second position the yarn is guided into the cot wheel 20, 30 being in the operating position for cutting glass fibres CG inline, i.e. during the automatic starting of the application and cutting process of the yarn Y (cf. FIGS. 5 to 7).

FIGS. 5 to 7 show schematic drawings of the automatic chopper 10 according to the present invention during the automatic application of a first strand, respectively the first yarn Y to be introduced into the chopper 10.

FIG. 5 shows the automatic application of the first strand in a first step. The yarn Y is guided through the oscillating comb 150 and guided by the idlers 100, 110 around the movable idler 130 and around the idler 120 down to the pulley wheels 140, 142. The pulley wheels 140, 142 cause a transportation of the yarn sheet into a trash chute.

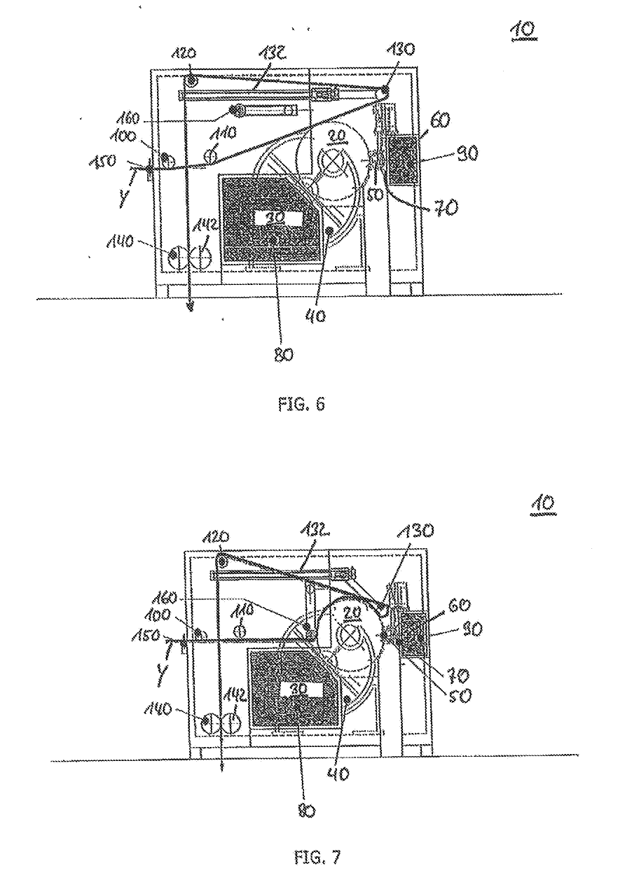

As can be derived from FIGS. 6 and 7, the movable idler 130 is configured such that by moving from the first position to the second position the yarn Y is guided into the cot wheel 20 being in the operating position for cutting glass fibres CG inline, preferably during the automatic starting of the insertion and cutting process of the yarn Y.

FIG. 6 shows the automatic laying of a first strand in a second step. The linearly movable idler 130 is moved along its guidance rail 132 from the first position shown in FIG. 5 to a second position shown in FIG. 6. This second position is above the first cot wheel 20 and the yarn Y is initially introduced into the cot wheel 20 by moving the movable idler 130 into the second position.

FIG. 7 shows the automatic laying of a first strand in a third step. The movable idler 130 is diverted from the second position shown in FIG. 6 towards the first cot wheel 20, thereby laying the yarn Y onto the cot wheel 20. To support this laying, the movable press roller 160 is diverted towards the first cot wheel 20 by also laying the yarn Y onto the cot wheel 20.

Thereby, the yarn Y is automatically transported to the cutter head 50 (60) and the cutting process begins.

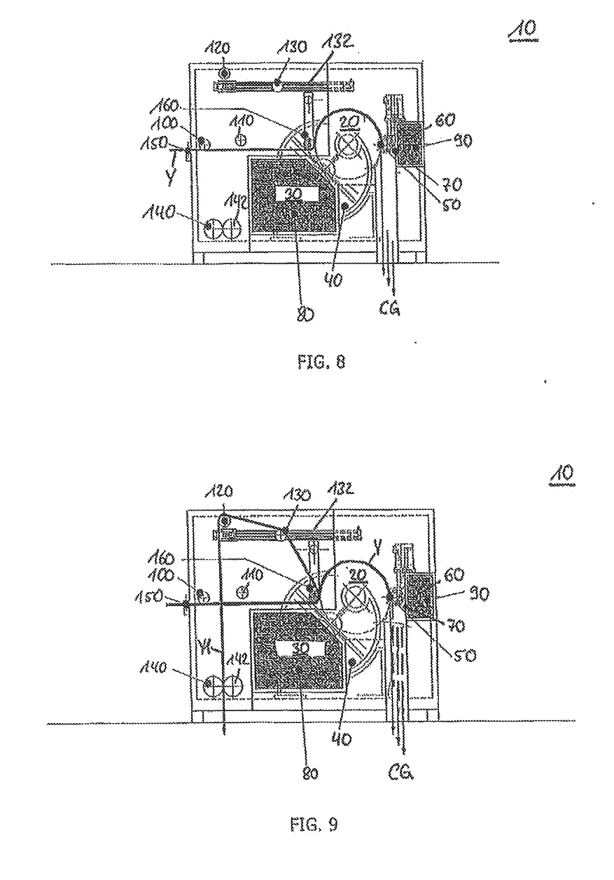

FIG. 8 shows the chopper 10 during the cutting process. When cutting is in operation, the yarn Y is guided by the oscillating comb 150, the idler 100 and the movable press roller 160. The yarn Y is laid onto the cot wheel 20, which is in operation and engaged with the first cutter head 50. The yarn Y is cut into cut glass fibres CG by passing through the engaged cot wheel 20 and the cutter head 50.

FIGS. 9 to 11 show schematic drawings of the automatic chopper 10 according to the present invention during the automatic application of a yarn sheet during the cutting.

FIG. 9 shows the automatic winding during the cutting process in a first step. A first yarn Y is cut as shown and described with respect to FIG. 8. A second yarn Y1 is applied automatically, similar to the first strand shown in FIGS. 5 to 7, however with little differences as described in the following.

The second yarn Y1 is guided through the oscillating comb 150 and guided by the idler 100, around the movable press roller 160, around the movable idler 130 and around the idler 120 down to the pulley wheels 140, 142. The pulley wheels 140, 142 provide an automatic discharge into the trash chute.

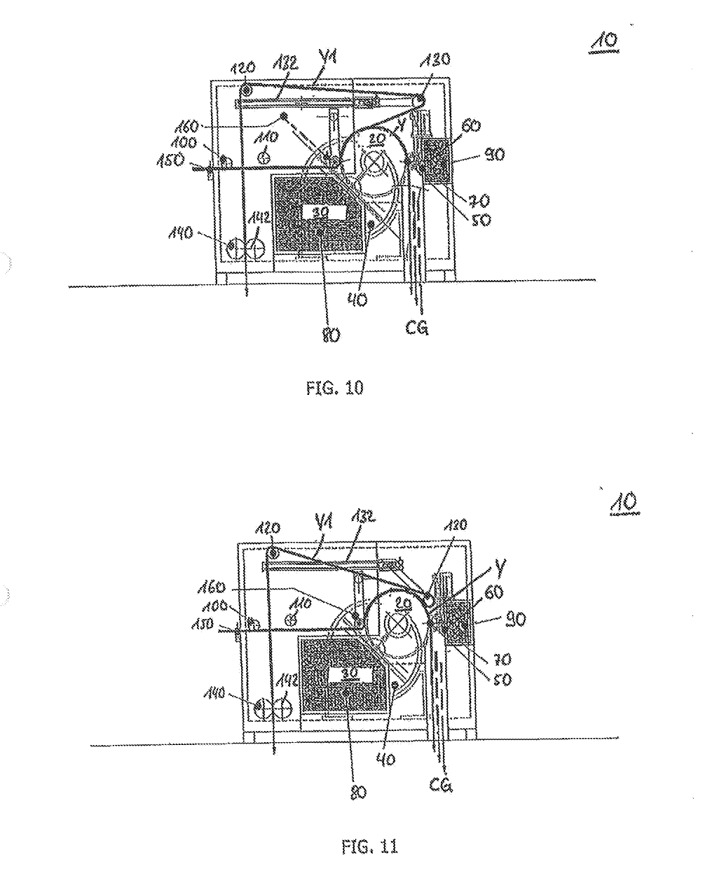

FIG. 10 shows the automatic application of a yarn sheet during the cutting process in a second step. The linearly movable idler 130 is moved along its guidance rail 132 from the first position shown in FIG. 9 to a second position shown in FIG. 10. This second position is above the first cot wheel 20 and the yarn Y1 is initially applied onto the cot wheel 20 by moving the movable idler 130 into the second position.

The movable idler 130 is deflected from the second position shown in FIG. 10 towards the first cot wheel 20, thereby applying the yarn Y onto the cot wheel 20 as can be derived from FIG. 11. Thus, FIG. 11 shows the automatic applying or laying during the cutting process of a first strand in a third step.

After the steps shown in FIGS. 9 to 11, the chopper 10 is again operated as shown in FIG. 8, i.e. in the cutting mode operation.

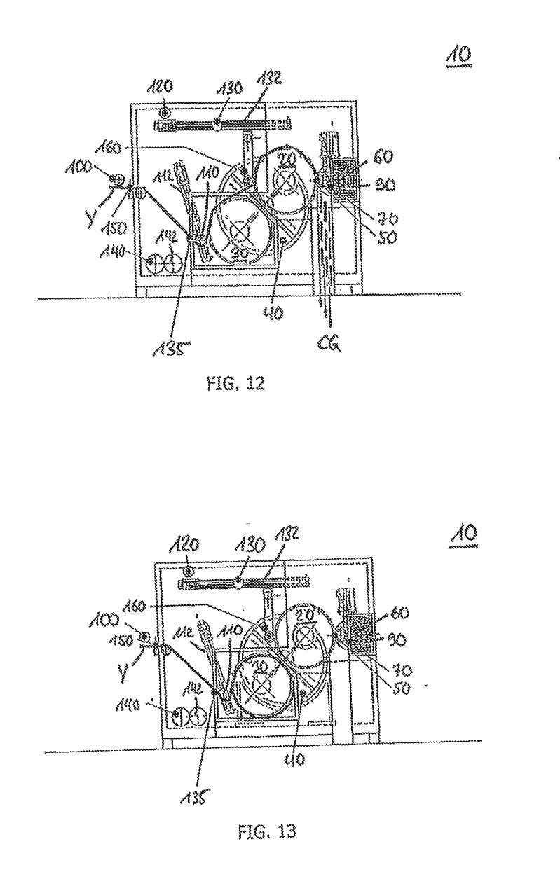

FIG. 12 shows the chopper 10 according to the present invention during automatic change over from the first cot wheel 20 to the second cot wheel 30 in a first step. Thereby, the second cot wheel 30 is running with production speed, i.e. in particular the speed of the first cot wheel 20.

The movable idler 110 is configured such that by moving from the first position to the second position the yarn Y is guided into the cot wheel 30, which is running with production speed, being in the non-operating position during the automatic change-over process when changing from the first cot wheel 20 to the second cot wheel 30 as shown in FIGS. 12 to 15.

The movable idler 110 is moving down along its guidance rail 112, thereby initially applying the yarn Y onto the second cot wheel 30. Thus, the yarn Y is guided through the oscillating comb 150, the idler 110, the cot wheel 30, then guided by the movable press roller 160 being engaged with the first cot wheel 20. The yarn is then guided by the first cot wheel to cutter head 50 which is in operation and cuts the yarn Y into cut glass fibres CG.

FIG. 13 shows the chopper 10 during automatic change over in a second step. The yarn Y is wound around the second cot wheel 30 to remove the first cot wheel from operation. Therefore, the yarn push off back one 135 is moving the yarn Y to a catcher 35 and the catcher 35 (see also FIGS. 17 a, b) is catching the yarn Y and the yarn Y is then running on the second cot wheel 30.

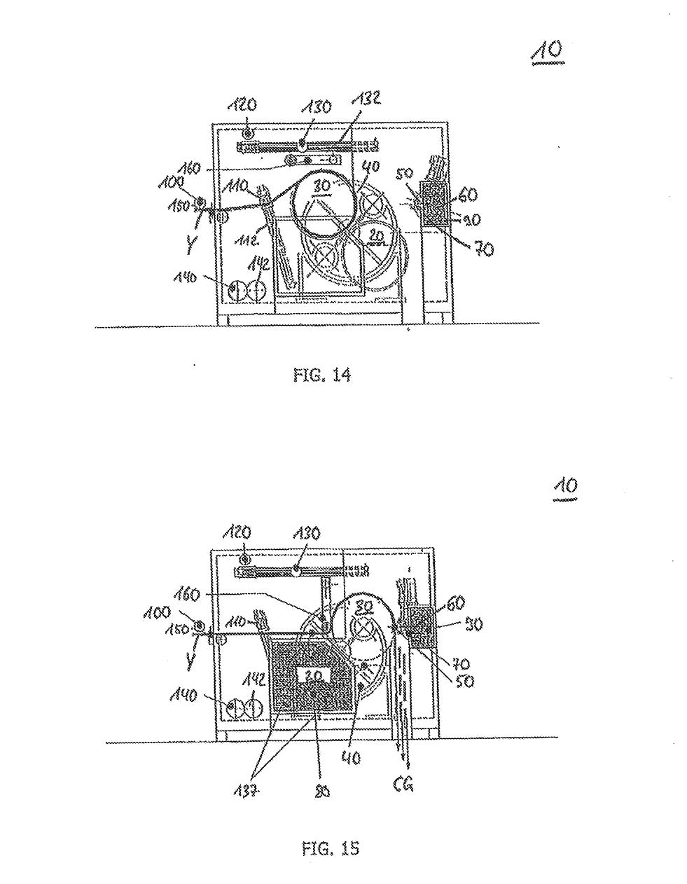

FIG. 14 shows the chopper 10 during automatic change over in a third step. Thereby, the movable press roller 160 and the cutterhead turret 70 with its cutter heads 50, 60 is swinging out of the collision circle of the rotating cot wheel turret 30 with the cot wheel 30 and the cot wheel 20. The idler 110 is moved in its upper position and the cot wheel 30 is transferred into the operating position.

FIG. 15 shows the chopper 10 during automatic change over in a fourth step, whereby both turrets 40 and 70 are now in the right position for operation. The front yarn push off 137 moves the yarn Y into the normal operating position. The press roller 160 and the cutter head 50 swing back into the working position.

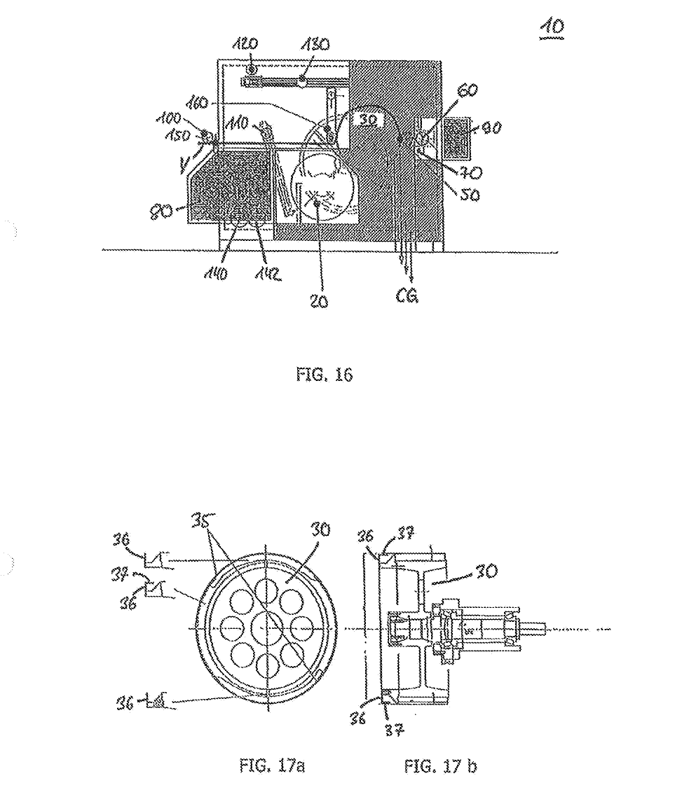

In a further schematic drawing FIG. 16 shows the chopper 10 after the automatic change over process of FIGS. 12 to 15. As is shown in FIG. 16, the cutting process is in operation and the safety door 80 is opened to change the first cot wheel 20. Meanwhile, the yarn Y is cut by means of the second cot wheel 30 and the cutter head 50. It is possible that during the third step of the automatic change over process as shown in FIG. 14 the first and the second cutter head 50, 60 exchange their positions, so that the first cutter head 50 can be exchanged also in the situation shown in FIG. 16.

FIG. 17a shows a front view of the cot wheel 30, whereby it is to be noted that the cot wheel 20 is identical. As can be seen in FIG. 17 a, the cot wheel 30 comprises two catchers 35, which are used in the automatic change over (see FIG. 13). The catchers 35 are cast of the boundary of the cot wheel 30 without a covering wall 37 of the border wall 36. FIG. 17b shows the cot wheel 30 of FIG. 17a in a side view.

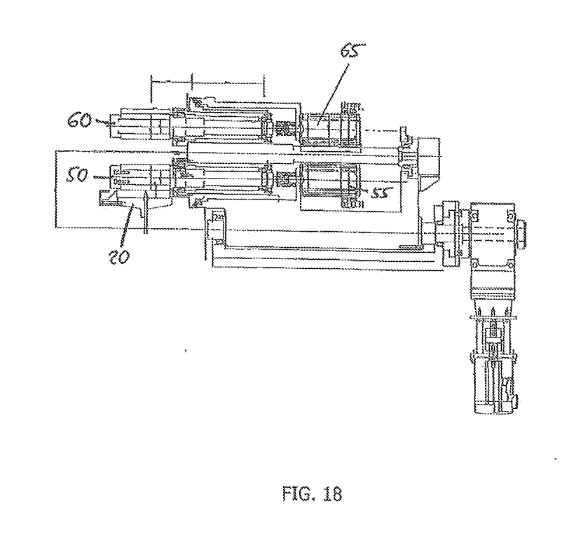

FIG. 18 shows an alternative embodiment of the drives 55, 65 of the cutting heads 50, 60. The difference compared to the embodiments shown in FIGS. 2 to 16 is that the embodiment of FIG. 18 comprises two small servo motors 55, 65, which drive the cutting heads 50, 60.

In one embodiment, the apparatus includes one or more computers having one or more processors and memory (e.g., one or more nonvolatile storage devices). In some embodiments, memory or computer readable storage medium of memory stores programs, modules and data structures, or a subset thereof for a processor to control and run the various systems and methods disclosed herein. In one embodiment, a non-transitory computer readable storage medium having stored thereon computer-executable instructions which, when executed by a processor, perform one or more of the methods disclosed herein.

It will be appreciated by those skilled in the art that changes could be made to the exemplary embodiments shown and described above without departing from the broad inventive concept thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and features of the disclosed embodiments may be combined. Unless specifically set forth herein, the terms “a”, “an” and “the” are not limited to one element but instead should be read as meaning “at least one”.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

I claim:

1. An apparatus for manufacturing cut glass fibres comprising:
at least one first cot wheel and at least one second cot wheel, a first cutter head and a second cutter head, whereby the apparatus is configured such that the apparatus is operable in at least one first operation mode in which at least one of the cot wheels and at least one of the cutter heads are capable to cut inline glass fibres from a yarn, preferably from an endless yarn.

2. The apparatus according to claim 1, wherein the first cot wheel and the second cot wheel are mounted on a cot turret, whereby the cot turret is movable from a first position to a second position and from the second position to the first position.

3. The apparatus according to claim 2, wherein the first position of the cot turret is a position, in which the first cot wheel is in an operating position for cutting glass fibres inline and/or that the second position of the cot turret is a position, in which the second cot wheel is in an operating position for cutting glass fibres inline.

4. The apparatus according to claim 2, wherein the first position of the cot turret is a position, in which the second cot wheel is in a non-operating position and detachable and/or that the second position of the cot turret is a position, in which the first cot wheel is in a non-operating position and detachable, whereby preferably in the first position of the cot turret the second cot wheel is accessible through at least one safety door and/or whereby preferably in the second position of the cot turret the first cot wheel is accessible through the at least one safety door.

5. The apparatus according to claim 2, wherein the cot turret is rotatable around a cot turret axis and that the first cot wheel is rotatable around a first cot wheel axis and the second cot wheel is rotatable around a second cot wheel axis, whereby the cot turret axis, the first cot wheel axis and the second cot wheel axis are substantially parallel.

6. The apparatus according to claim 1, wherein the first cutter head and the second cutter head are mounted on a cutterhead turret, whereby the cutterhead turret is movable from a first position to a second position and from the second position to the first position.

7. The apparatus according to claim 6, wherein the first position of the cutterhead turret is a position, in which the first cutter head is in an operating position for cutting glass fibres inline and/or that the second position of the cutterhead turret is a position, in which the second cutter head is in an operating position for cutting glass fibres inline.

8. The apparatus according to claim 6, wherein the first position of the cutterhead turret is a position, in which the second cutter head is in a non-operating position and detachable and/or that the second position of the cutterhead turret is a position, in which the first cutter head is in a non-operating position and detachable, whereby preferably in the first position of the cutterhead turret the second cutter head is accessible through at least one safety door and/or whereby preferably in the second position of the cutterhead turret the first cutter head is accessible through the at least one safety door.

9. The apparatus according to claim 6, wherein the cutterhead turret is rotatable around a cutterhead turret axis and that the first cutter head is rotatable around a first cutter head axis and the second cutter head is rotatable around a second cutter head axis, whereby the cutterhead turret axis, the first cutter head axis and the second cutter head axis are substantially parallel.

10. The apparatus according to claim 1, wherein the apparatus comprises at least one idler, whereby the idler is configured such that the yarn can be guided by means of the idler.

11. The apparatus according to claim 10, wherein the apparatus comprises at least one movable idler being movable from at least a first position to a second position and backwards.

12. The apparatus according to claim 11, wherein the movable idler is configured such that by moving from the first position to the second position the yarn is guided into the cot wheel being in the non-operating position, preferably during the automatic change-over process when changing from the first cot wheel to the second cot wheel or from the second cot wheel to first cot wheel and/or that the movable idler is configured such that by moving from the first position to the second position the yarn is guided into the cot wheel being in the operating position for cutting glass fibres inline, preferably during the automatic starting of the insertion and cutting process of the yarn.

13. The apparatus according to claim 1, wherein the apparatus comprises at least one set of at least two pulley wheels, whereby the pulley wheels are configured such that the pulley wheels are capable to pull the yarn, preferably during the automatic starting of the insertion and cutting process of the yarn.

14. The apparatus according to claim 1, wherein the apparatus comprises at least one movable press roller being movable from at least a first position to a second position and backwards, whereby preferably the movable press roller is configured such that by moving from the first position to the second position the yarn is guided into the cot wheel being in the operating position for cutting glass fibres inline, preferably during the automatic starting of the insertion and cutting process of the yarn.

15. The apparatus according to claim 1, wherein the apparatus comprises at least one oscillating comb, which is configured such that the incoming yarn is guided by the oscillating comb.
